(19) United States
(12) Patent Application Publication
(10) Pub. No.: US 2003/0001799 A1
(43) Pub. Date: Jan. 2, 2003

(54) Method of driving a plasma display panel

(75) Inventor: Kwang Bae Bae, Kyungsangbuk-do (KR)

Correspondence Address: MERCHANT & GOULD PC, P.O. BOX 2903, MINNEAPOLIS, MN, 55402-0903, US

(73) Assignee: Orion Electric Co., Ltd, Kyungsangbuk-do (KR)

(21) Appl. No.: 10/163,166

(22) Filed: Jun. 4, 2002

Related U.S. Application Data
(63) Continuation-in-part of application No. 09/451,992, filed on Nov. 30, 1999.

(30) Foreign Application Priority Data
Nov. 30, 1998 (KR) 1998-52066

(51) Int. Cl. G09G 3/10

(52) U.S. Cl. 345/37

(57) ABSTRACT

A method of driving a plasma display panel uses a frame time-division multiplexing method wherein a frame is divided into a plurality of subfields and each subfield is allocated to a different sustain period. In this method, a frame is divided into two groups, and the number of subfields wherein a preliminary discharge is performed on each group is made to be the same or smaller than that of subfields wherein a preliminary discharge is not performed. Under this condition, thereby preventing the deterioration of the selective write rate due to an unequal discharge condition among cells and improving contrast by lowering background brightness of the picture.

### FIELD OF THE INVENTION

The present invention relates to a method of driving a plasma display panel, and more particularly to a method of driving a plasma display panel for forming a space charge by performing a preliminary discharge in the predetermined number of subfields and addressing/performing a sustain discharge in a different subfield using the space charge formed in the subfield wherein the preliminary discharge is performed.

### BACKGROUND OF THE INVENTION

Recently, a display device employing a plasma display panel (hereinafter referred to as a PDP) has been developed and produced that satisfies a demand for a large screen but a small thickness and wide viewing angle compared to other flat display devices.

FIG. 1 is a partially sectional view of a discharge cell of a general PDP 10. As shown, PDP 10 comprises a front plate 13 having X electrode 14 and Y electrode 15 formed thereon, a rear plate 12 having an address electrode 16 formed thereon, a dielectric layer 18 formed on the first and second electrodes 14 and 15, a MgO layer 21 covering the dielectric layer 18, a barrier rib defining a discharge cell and a phosphor layer 19 covering the address electrode 16 and being formed on a side wall of the barrier rib 17.

As a method of driving such PDP, for example, an alternating current (AC) PDP, there is a frame-division addressing and display period division driving method.

According to this method, one frame is divided into eight subfields SF1 through SF8 and each of the subfields comprises a reset period, an addressing period and a display period.

During the reset period, in order to reset all the cells, that is, to equalize discharge conditions of the cells, a write pulse of a sufficient amplitude, for example, 350 V, is applied to a X sustain electrode and performs a preliminary discharge for all the cells. As a result, a sufficient space charge is formed within the discharge cell and a wall charge is accumulated on the dielectric layer covering the electrodes. If applying an erase pulse to the X sustain electrode, the accumulated wall charge is erased and thus discharge conditions of all the cells are equalized.

During the addressing period, also, in order to designate cells to be displayed in accordance with an image data with respect to the reset cells, a scan pulse is applied to the Y electrode and at the same time, a data pulse is applied to an address electrode in accordance with an image data to be displayed. Consequently, the wall charge which was erased during the reset period is accumulated again on the cell to which data pulse is applied. However, the wall charge is not accumulated on the cell to which data pulse is not applied. During the addressing period, a separate space charge is not produced and the space charge, which was generated through a preliminary discharge or a whole-screen discharge during the above reset period, is used.

During the display period, in order to perform a sustained discharge, a sustain pulse is applied and an amplitude of the sustain pulse to be applied is determined in a consideration of wall charge being accumulated on the dielectric layer. Accordingly, during the display period, a cell having a wall charge accumulated thereon (a cell designated to be displayed) performs a sustained discharge by means of a sustain pulse. However, a cell on which a wall charge is not accumulated cannot perform the sustained discharge even though a sustained discharge pulse is applied thereto.

As shown in FIG. 2, in a driving method for a conventional PDP, a preliminary discharge is performed for all the subfields SF1 through SF8 in one frame. Accordingly, by resetting the condition of all the discharge cells before addressing with respect to each subfield, discharge conditions of all the cells are equalized, thereby performing a stabilized data write.

However, when displaying a black color without writing data to all the subfields, the background brightness becomes very high due to the preliminary discharge performed for each subfield.

In general, it is known that background brightness is approximately 0.5 cd/m² per one preliminary discharge. Accordingly, if performing a preliminary discharge for all the subfields, the background brightness becomes very high and a contrast becomes low, relatively. Also, if the background brightness becomes high, a mixing rate of color becomes high, thereby having a serious influence on color reproducibility.

As another method of driving PDP capable of solving such a problem, there has been suggested a method in which one-time preliminary discharge is performed for only the first subfield in every frame and the preliminary discharge is not performed for the remaining subfields. (See a unexamined Japanese patent publication No. Hei 5-313598)

This method will be explained simply with reference to FIG. 3. As shown, during a reset period of the first subfield SF1 in one frame, in order to reset all the cells, a sufficient space charge is formed on the cells by performing a preliminary discharge and thus a wall charge is accumulated on a dielectric layer covering electrodes. Thereafter, the accumulated wall charge is erased by applying an erase pulse thereto. During an addressing period, in order to designate a cell to be displayed, a wall charge is accumulated on the dielectric layer in accordance with an image data by using the space charge generated through the preliminary discharge or a whole-screen discharge during the above reset period. Thereafter, during display period, a display of one subfield is completed by applying a sustain pulse for a sustained discharge.

During the period for resetting the second subfield SF2 through the last subfield SF8, neither a preliminary discharge nor a whole-screen discharge is performed. A wall charge accumulated on the cells, in which a preliminary discharge was performed for the first subfield SF1, is erased and then an addressing is performed.

Accordingly, the above method can have an advantage that by performing one preliminary discharge per one frame, the background brightness becomes very low and the contrast is improved.

However, this method has the following problems. That is, since the space charge generated through the first preliminary discharge is used to address all the subfields SF1 through SF8, a space charge decreases as the number of subfields increases. As a result, when addressing the succeeding subfields, the rate of data write gradually declines. Also, since a partial resetting for erasing a wall charge with respect to only the cells that have performed a sustained discharge in the previous subfield is performed, the more the number of the subfields is increased, and the more a discharge condition of all the subfields becomes unequal, resulting in the deterioration of the rate of data write.

In order to prove such problems, the present inventor conducted an experimentation regarding a relationship between each of the subfields and a preliminary discharge applied thereto in the three-electrode type, a surface-discharging PDP manufactured by a thick film manufacturing process. In the experimentation, the panel used a dynamic margin of about 10V, a driving voltage of about 170V, an addressing voltage of about 70V. Also, as an applied pattern, a white window pattern of an APL non-response area was used.

FIGS. 3 and 4 show the rate of data write represented as the result of the experimentation.

FIG. 3 shows the rates of data write when a preliminary discharge was performed for all the subfields as shown in the FIG. 1. As seen, when performing a preliminary discharge for each of the subfields, the rate of data write showed a totally stabilized state. However, as described above, it showed a problem that the background brightness becomes high and thus the contrast is deteriorated.

FIG. 4 shows the rate of data write when performing a preliminary discharge for only the first subfield SF1 as shown in FIG. 2. In this case, the rate of data write becomes unstable from when the 5th subfield, SF5, is displayed. Also, the driving voltage rises to 180 V and thermal saturation brightness falls to 168 cd/m².

### SUMMARY OF THE INVENTION

Accordingly, an object of the present invention is providing a driving method for PDP capable of improving contrast by lowering background brightness of a picture, improving color reproducibility by reducing mixing rate of color, and performing a stabilized image display by improving rate of data write.

In order to achieve the above object, a driving method of a PDP in accordance with a preferred embodiment of the present invention is characterized by that in a method of driving a plasma display panel for dividing a frame into a plurality of subfields and displaying sequentially the divided subfields including an addressing period for accumulating a wall charge on a cell to be displayed by applying a scan pulse and a data pulse thereto and a sustain period for performing a sustained discharge by applying a predetermined number of sustained discharge pulse allocated to the corresponded subfields to cells having a wall charge accumulate thereon, comprising: a first group of the plurality of subfields including the predetermined number of former subfields; a second group of the plurality of subfields including the rest subfields, wherein the number of subfields having a reset period is the same or smaller than that of subfields having no reset period, the reset period for equalizing the discharge condition of all the cells by performing a preliminary discharge, which applies a strong write pulse to all the cells, with respecto to the cells so that a wall charge is accumulated on the cells, erasing the wall charge by means of a self erasing and then erase-discharging the cells.

### BRIEF DESCRIPTION OF THE DRAWINGS

Now, embodiments of the present invention will be described in detail with reference to the accompanying drawings, wherein

FIG. 1 shows a partially sectional view of a general PDP;

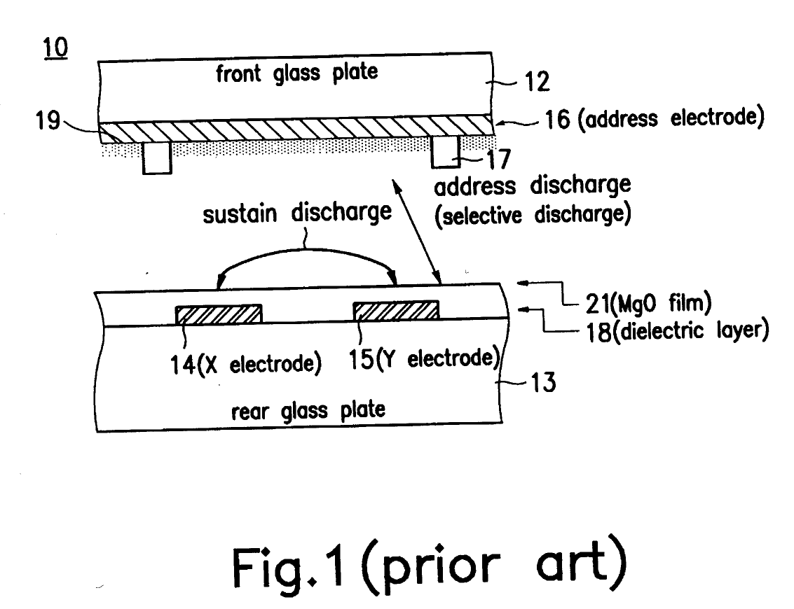

FIG. 2 is a timing diagram illustrating an example of a driving method for a conventional PDP;

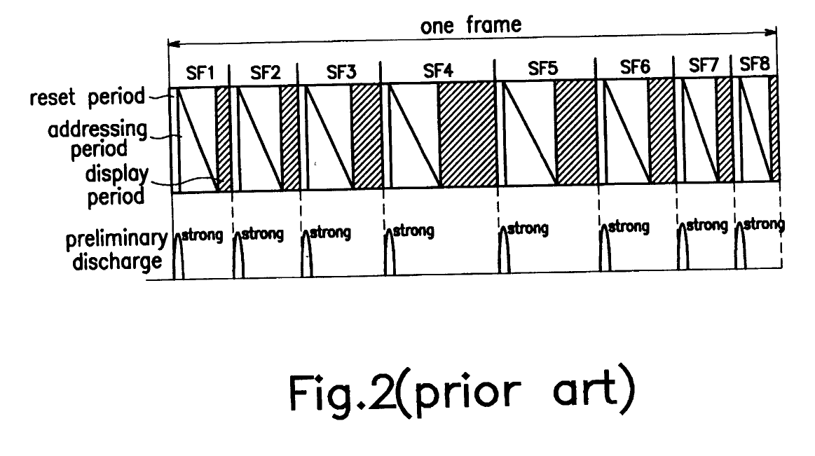

FIG. 3 is a timing diagram illustrating another example of a driving method for a conventional PDP;

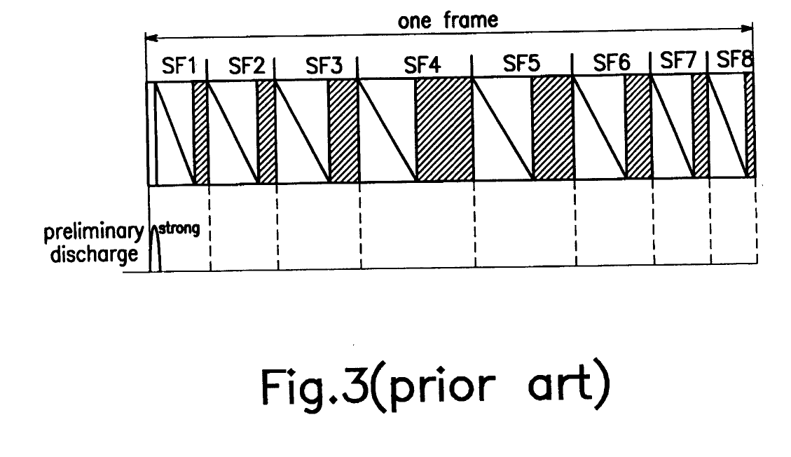

FIG. 4 shows a rate of data writes in the driving method in accordance with FIG. 1;

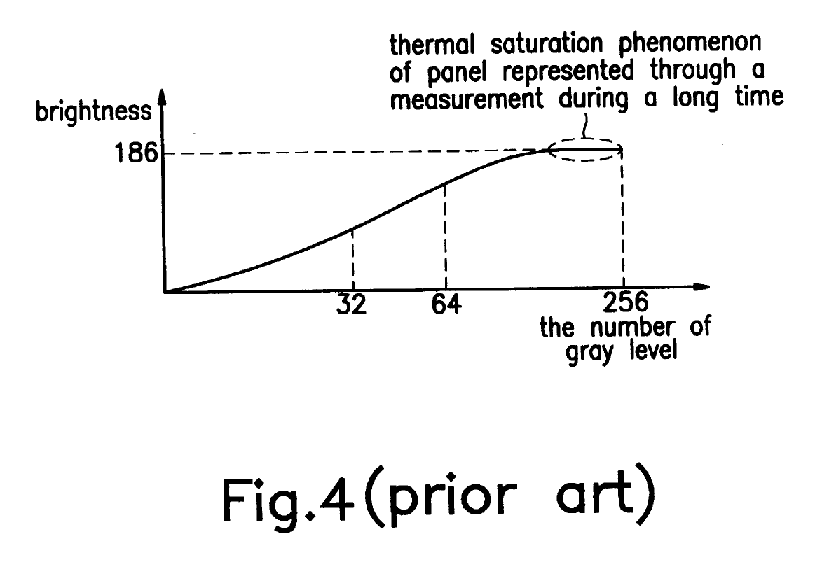

FIG. 5 shows a rate of data writes in the driving method in accordance with FIG. 2;

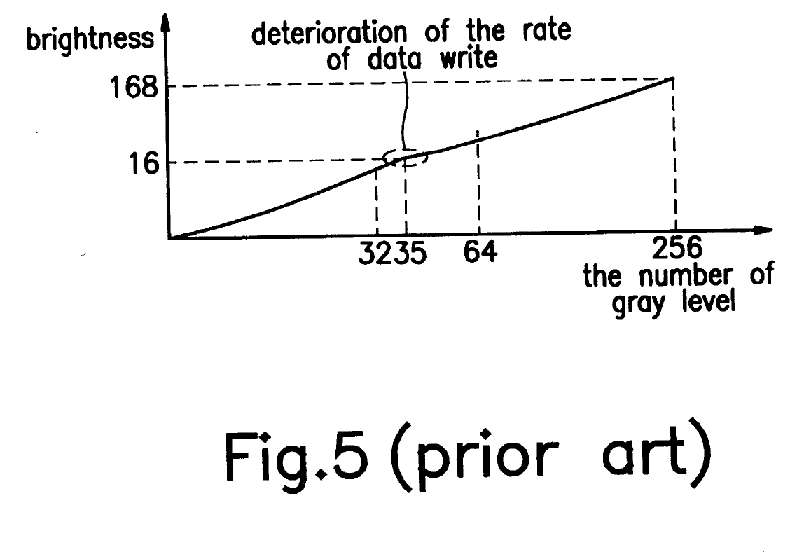

FIG. 6 is a timing diagram illustrating a driving method for a PDP in accordance with a first embodiment of the present invention;

FIG. 7 is a timing diagram illustrating a driving method for a PDP in accordance with a second embodiment of the present invention;

FIG. 8 is a timing diagram illustrating a driving method for a PDP in accordance with a third embodiment of the present invention;

FIG. 9 is a driving waveform diagram of PDP applied to the first subfield and the fifth subfield in accordance with the first embodiment of the present invention;

FIG. 10 is a driving waveform diagram of PDP applied to second through the fourth subfields and the sixth through the eighth subfields in accordance with the first embodiment of the present invention;

FIG. 11 is a driving waveform diagram of PDP applied to the fifth subfield in accordance with the second embodiment of the present invention;

FIG. 12 shows a rate of data write in the driving method in accordance with a first embodiment of the present invention; and

FIG. 13 shows a rate of data write in the driving method in accordance with a second embodiment of the present invention.

### DETAILED DESCRIPTION OF THE PREFERRED EMBODIMENTS

The present invention is directed to an addressing period—displaying period division driving method in which one frame is divided into eight subfields SF1 through SF8 and a brightness is established differently for each subfield. Each subfield comprises a reset period, an addressing period and a displaying period.

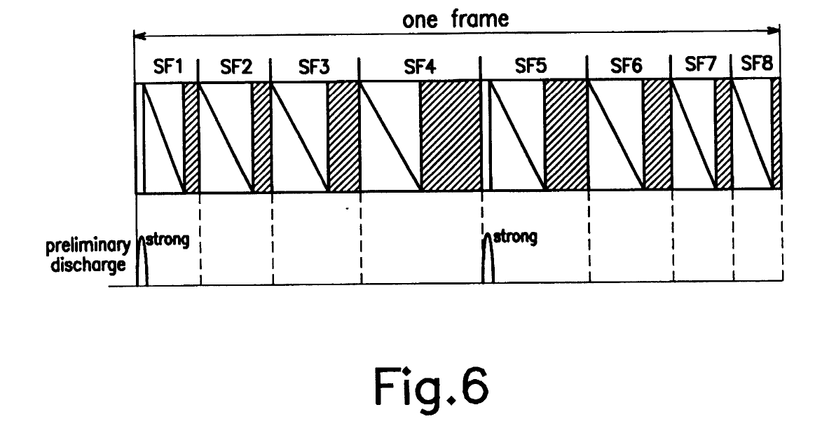

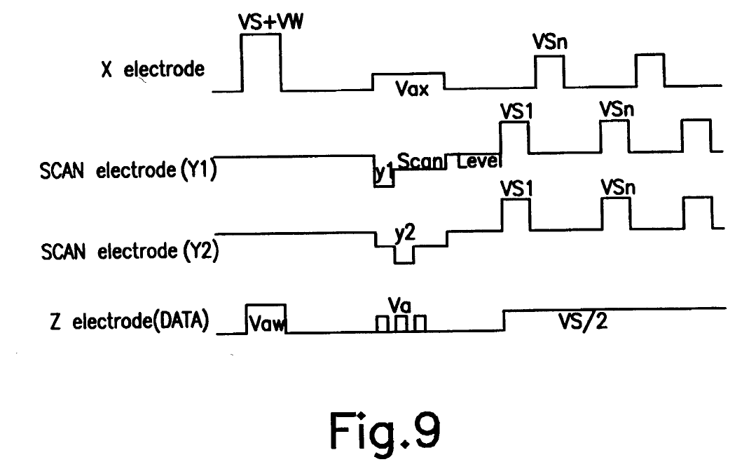

FIGS. 6 and 9 show a timing diagram illustrating a driving method for a PDP in accordance with a first embodiment of the present invention and a driving waveform diagram of PDP applied to 1st subfield, respectively.

During the reset period for resetting the first subfield SF1, a write pulse of a sufficient amplitude, for example, 350 V, is applied to a X sustain electrode and performs a strong preliminary discharge. As a result, due to the preliminary discharge, a sufficient space charge is formed within discharge spaces of all the cells and a wall charge is accumulated on a dielectric layer covering display electrodes. Then, If applying a write pulse, an electric field is formed by the accumulated wall charge. Herein, since the electric field is strong enough to initiate a self-discharge, it causes a self-erasing discharge. Accordingly, the wall charge accumulated on all the cells is erased by the self-erasing discharge and thus discharge conditions of all the cells are equalized.

Next, in the addressing period, a scan pulse is applied to the Y scan electrodes and at the same time, a data pulse in accordance with an image data is applied to an address electrode. Accordingly, a wall charge is accumulated again on cells to be displayed by means of the space charge, but is not accumulated on cells not to be displayed. Then, by applying the number of sustain pulses much as the number set to the first subfield to all the cells, a sustained discharge is performed in proportion to the number of sustain pulses. After completing the sustained discharge, an erase pulse is applied to all the cells. At this time, only the wall charge accumulated on the cell for which a sustained discharge was performed in the first subfield is erased and then a display of one subfield is completed.

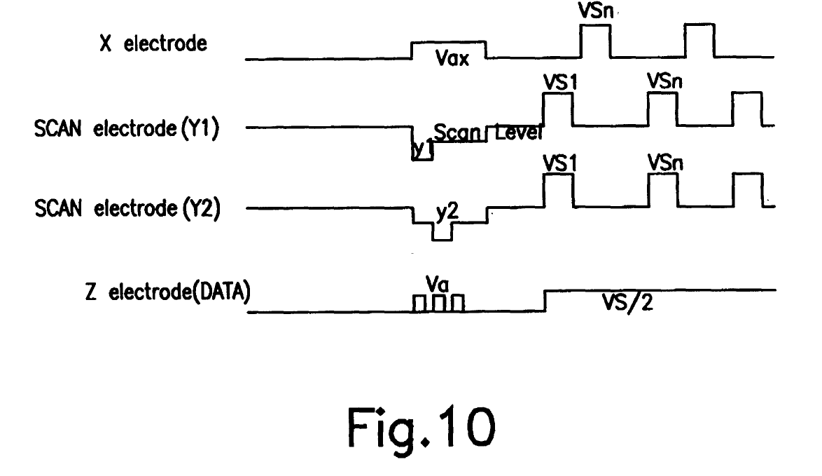

Then, as shown in FIGS. 6 and 10, by using the space charge formed in the previous subfield SF1 without performing a preliminary discharge for the second through fourth subfields, an addressing is performed and then a sustained discharge is performed.

Thereafter, in the reset period of the fifth subfield SF5, by performing a strong preliminary discharge through a re-application of a write pulse of a sufficient amplitude to the X sustain electrode, a sufficient space charge is formed again on the discharge spaces of all the cells, a wall charge is accumulated on the dielectric layer covering display electrodes.

Then, if applying a write pulse thereto, an electric field is formed by the accumulated wall charge. Since the electric field is strong enough to initiate a self-discharge, it causes a self-erasing discharge. Accordingly, the wall charge accumulated on all the cells is erased by the self-erasing discharge and thus discharge conditions of all the cells are equalized again.

Next, after performing an addressing using the formed space charge, a sustained discharge is performed as much as the number set to the fifth subfield to all the cells and then an erase pulse is applied, thereby completing a display of the fifth subfield SF5.

Thereafter, as shown in FIGS. 6 and 10, a preliminary discharge is not performed from the sixth subfield SF6 to the eighth subfield SF8. Instead, a sustain discharge is performed after addressing is performed using a space charge formed in the previous subfield SF1.

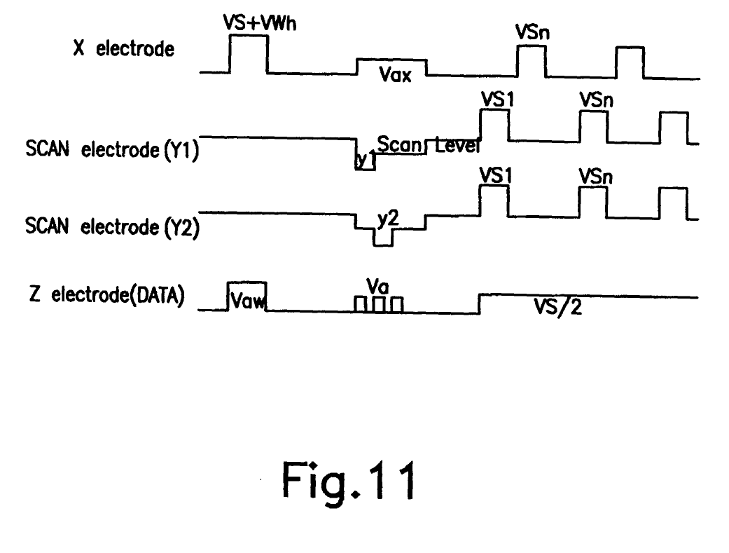

As mentioned above, in accordance with the present invention, if performing an one-time preliminary discharge for each of the first subfield and the fifth subfield in accordance with the present invention, it is possible to obtain a stabilized data writing, compared to the case that a preliminary discharge is performed only for the first subfield SF1 as shown in FIG. 11. That is, by addressing subfields continuously after the preliminary discharge in the first subfield SF1, the deterioration of the rate of data write does not occurred. Also, even though the driving voltage rises slightly, the thermal saturation brightness rises to 182 cd/m² compared to the prior art.

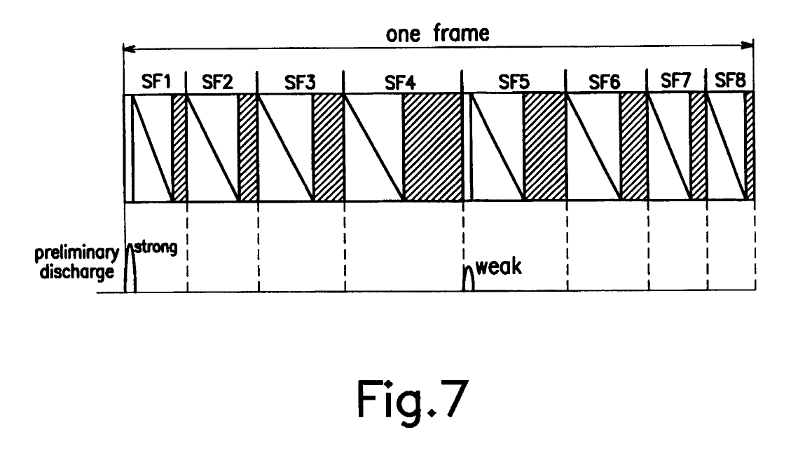

FIGS. 7 and 11 are a timing diagram illustrating a driving method in accordance with a second embodiment of the present invention and a driving waveform diagram of PDP applied to 5th subfield, respectively.

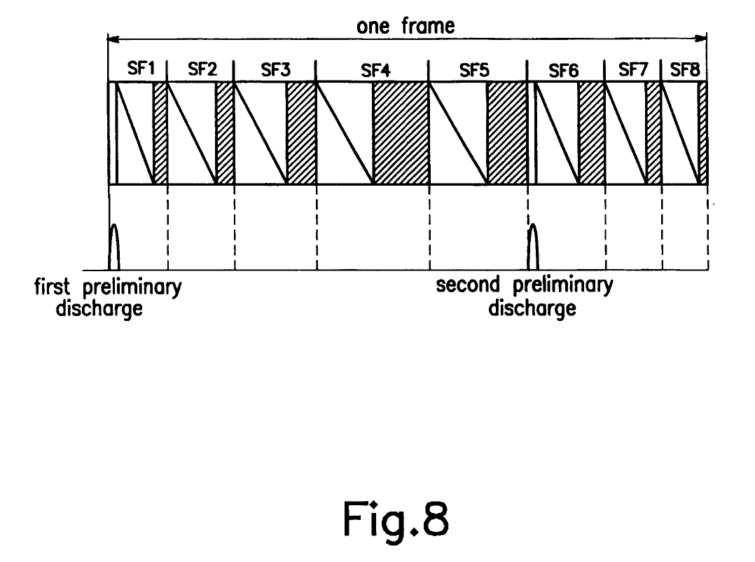

In the first subfield SF1, as shown in FIG. 8, a strong preliminary discharge and self-erasing discharge is performed applying a strong write pulse VS+VW. In the fifth subfield SF5, a weak write pulse VS+VWh is applied and thus a weak preliminary discharge is performed. Accordingly, the background brightness is reduced relatively, thereby improving the contrast more.

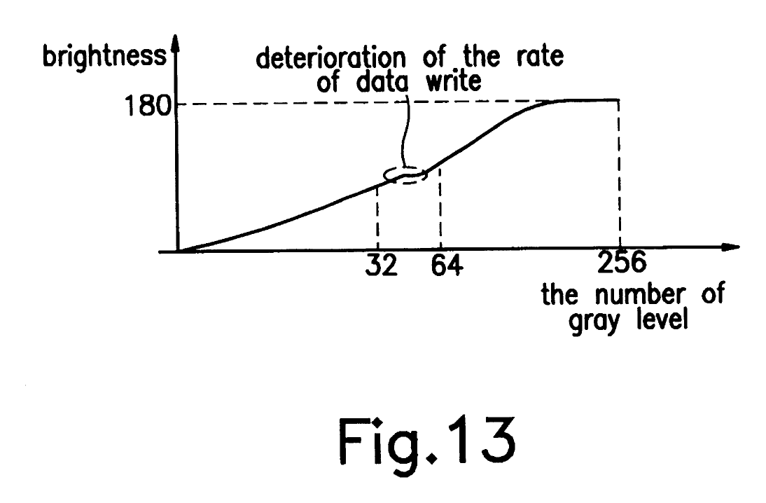

As shown in FIGS. 8 and 13, in accordance with a third embodiment of the present invention, in the reset period of the first subfield SF1, a strong preliminary discharge is performed by applying a write pulse of a sufficient amplitude to the X sustain electrode. Accordingly, a sufficient space charge is formed on the discharge spaces of all the cells and a sufficient wall charge is accumulated on the dielectric layer covering display electrodes. Then, if applying a write pulse thereto, an electric field is formed by the accumulated wall charge. At this time, since the electric field is strong enough to initiate a self discharge, it causes a self-erasing discharge. Accordingly, the wall charge accumulated on all the cells is erased by the self-erasing discharge and thus discharge conditions of all the cells are equalized during the reset period of the subfield.

Next, in the addressing period, a scan pulse is sequentially applied to the Y electrode and at the same time, a data pulse is applied to an address electrode in accordance with data to be displayed. Accordingly, a wall charge is accumulated on cells to be displayed by means of the space charge, but it is not accumulated on cells not to be displayed. Then, by applying sustain pulses as much as the number set to the first subfield to all the cells, a sustained discharge is performed on the cells having a wall charge, in proportion to the number of sustain pulses. After completing the sustained discharge, an erase pulse is applied all the cells. At this time, only the wall charge accumulated on the cell for which a sustained discharge was performed in the first subfield is erased and then a display of one subfield is completed.

Then, as shown in FIGS. 6 and 10, by using the space charge formed in the previous subfield SF1 without performing a preliminary discharge from the second subfield SF2 to the fifth subfield SF5, an addressing is performed and then a sustained discharge is performed.

Thereafter, as shown in FIGS. 6 and 9, in the reset period of the sixth subfield SF6, by performing a strong preliminary discharge through a re-application of a write pulse of a sufficient amplitude to the X sustain electrode, a sufficient space charge is formed again on the discharge spaces of all the cells and a wall charge is accumulated on the dielectric layer covering display electrodes. Then, if applying a write pulse thereto, an electric field is formed by the accumulated wall charge. At this time, since the electric field is strong enough to initiate a self-discharge, it causes a self-erasing discharge. Accordingly, the wall charge accumulated on all the cells is erased by the self-erasing discharge and thus discharge conditions of all the cells are equalized again.

Next, after performing an addressing using the formed space charge, a sustained discharge is performed as much as the number set to the sixth subfield is applied to all the cells and then an erase pulse is applied, thereby completing a display of the sixth subfield SF6.

Thereafter, as shown in FIGS. 6 and 10, by using the space charge formed in the sixth subfield SF6 without performing a preliminary discharge for the seventh subfield SF7 to eighth subfield SF8 as in the case of the second subfield SF2 through the fifth subfield SF5, an addressing is performed and then a sustained discharge is performed.

In this way, if performing an one-time preliminary discharge for each of the first subfield SF1 and the sixth subfield SF6 in accordance with the third embodiment of the present invention, it is possible to obtain a stabilized data write, compared to the case that a preliminary discharge is performed only for the first subfield SF1.

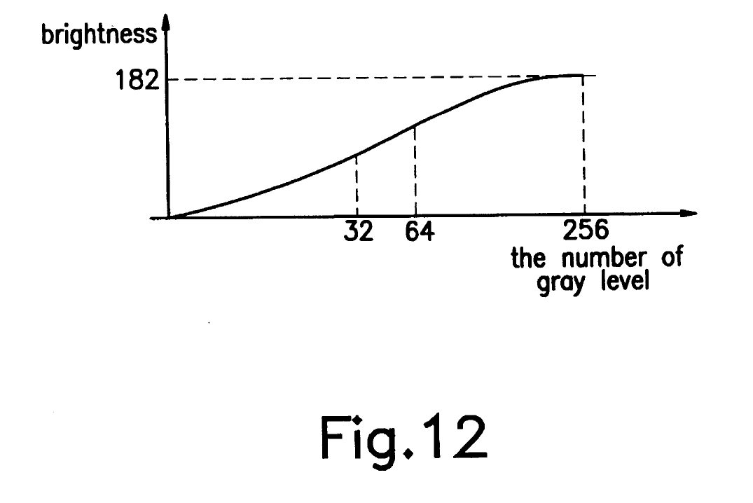

FIG. 13 shows a rate of data write in the driving method in accordance with a second embodiment of the present invention. As shown in FIG. 12, even though there was a deterioration of the rate of data writing in the fifth subfield SF5, it was disappeared due to a re-creation of the space charge in accordance with the sixth preliminary discharge.

Although an example including two subfields for performing a preliminary discharge in a frame is explained in the above-described embodiments, the number of subfields for performing a preliminary discharge can be plural if necessary. That is, the number of subfields having a reset period is made to be the same or smaller than that of subfields having no reset period.

As explained above, in accordance with the present invention, a space charge is formed by performing the preliminary discharge in the first subfield at every frame and thereafter a space charge is re-formed by performing the preliminary discharge in the subfield in the middle portion. Accordingly, the background brightness of a picture can be minimized, thereby improving the contrast. As a result, a mixing rate of color can be reduced and thus color reproducibility can be improved, thereby improving a yield of the products.

In addition, if all subfields include reset periods by dividing a frame into a plurality of subfields, the operating range is large but contrast is degraded. If a subfield includes a reset period, the operating range becomes small, thereby resulting in differences between cells. However, the number of subfields having a reset period is made to be the same or smaller than that of subfields having no reset period. As a result, the present invention enables the operating range to be maintained at a proper level, thereby resulting in improving contrast.

Many different embodiments of the present invention may be conducted without departing from the spirit and scope of the present invention is not limited to the specific embodiments described in the specification.

What is claimed is:

1. A method of driving a plasma display panel for dividing a frame into a plurality of subfields and displaying sequentially the divided subfields including an addressing period for accumulating a wall charge on a cell to be displayed by applying a scan pulse and a data pulse thereto and a sustain period for performing a sustained discharge by applying a predetermined number of sustained discharge pulse allocated to the corresponded subfields to cells having a wall charge accumulate thereon, comprising:
a first group of the plurality of subfields including the predetermined number of former subfields;
a second group of the plurality of subfields including the rest subfields,
wherein the number of subfields having a reset period is the same or smaller than that of subfields having no reset period, the reset period for equalizing the discharge condition of all the cells by performing a preliminary discharge, which applies a strong write pulse to all the cells, with respecto to the cells so that a wall charge is accumulated on the cells, erasing the wall charge by means of a self erasing and then erase-discharging the cells.

2. The method according to claim 1, wherein one or more of the sizes of write pulses for performing a preliminary discharge in subfields having the reset period is used.

3. A method driving a plasma display panel, wherein the number of subfields having a reset period is made to be smaller than that of subfields having no reset period among subfields included in a frame.

4. The method according to claim 3, wherein one or more of the sizes of write pulses for performing a preliminary discharge in subfields having the reset period is used.
